(19) United States
(12) Patent Application Publication
(10) Pub. No.: US 2024/0075768 A1
(43) Pub. Date: Mar. 7, 2024

(54) SPINDLE REPAIR APPARATUS AND METHOD

(71) Applicant: Axle Spindle Inc., Brampton (CA)

(72) Inventor: Satwinder Bajwa, Mississauga (CA)

(21) Appl. No.: 18/203,288

(22) Filed: May 30, 2023

Related U.S. Application Data
(60) Provisional application No. 63/346,928, filed on May 30, 2022.

(51) Int. Cl. B60B 27/00; F16D 65/00

(52) U.S. Cl. CPC B60B 27/0052; F16D 65/0056; B60B 2320/10; B60B 2900/113; B60B 2900/541

(57) ABSTRACT

The apparatus is for use with a mechanism of the type which, when manufactured, has an axle tube terminating in a brake mount, a spindle extending from the brake mount, a spider plate mounted to the brake mount in surrounding relation to the spindle, a hub mounted to the spindle and a wheel mounted to the hub. The apparatus is adapted to receive the hub in the manner of the spindle, adapted to be mounted to the brake mount and adapted to capture the spider plate against the brake mount.

### REFERENCE TO RELATED APPLICATION

This application claims priority to U.S. Provisional Patent Application Ser. No. 63/346,928, filed May 30, 2022, the entire content of which is incorporated herein by reference.

### FIELD OF THE INVENTION

The invention relates to the field of axle spindle repair.

### BACKGROUND OF THE INVENTION

In the field of road transport, the repair of axle spindles is commonplace.

A typical approach to repair involves:
removal of the wheel, hub, brake and spider
severing the damaged spindle
securing a fixture
positioning a replacement spindle with the fixture
welding the replacement spindle in place
removing the fixture and reinstalling the spider, brake, hub and wheel

Since the conveyance in need of repair is often very large and not road worthy, repair often takes place in remote locations and roadside. The need to transport the necessary equipment for the above means that repair can be relatively time consuming and costly.

### SUMMARY OF THE INVENTION

Forming one aspect of the invention is apparatus for use with a mechanism of the type which, when manufactured, has an axle tube terminating in a brake mount, a spindle extending from the brake mount, a spider plate mounted to the brake mount in surrounding relation to the spindle, a brake assembly mounted to the brake mount in surrounding relation to the spindle, a hub mounted to the spindle and a wheel mounted to the hub.

The apparatus comprises an assembly adapted to receive the hub in the manner of the spindle, adapted to be mounted to the brake mount in the manner of the spider plate and adapted to receive the brake in the manner of the spider plate.

According to another aspect of the invention, the assembly can comprise:
a spindle portion having a spindle part that is adapted to receive the hub in the manner of the spindle and a flange part from which the spindle part protrudes; and
a spider portion having a hollow adapted to receive the flange part, the spider portion and the flange part being adapted to be mounted to the brake mount in the manner of the spider plate and adapted to receive the brake in the manner of the spider plate.

The apparatus can be used in a method which forms another aspect of the invention.

The method is for repairing a damaged spindle in a mechanism of the type which, when manufactured, has: an axle tube terminating in a brake mount; a spindle extending from the brake mount; a spider plate mounted to the brake mount in surrounding relation to the spindle; a brake assembly mounted to the brake mount in surrounding relation to the spindle; a hub mounted to the spindle; and a wheel mounted to the hub; and comprises operatively mounting the apparatus to the brake mount.

Forming another aspect of the invention is apparatus for use with a mechanism of the type which, when manufactured, has: an axle tube terminating in a brake mount; a spindle extending from the brake mount; a spider plate mounted to the brake mount in surrounding relation to the spindle; a hub mounted to the spindle; and a wheel mounted to the hub.

This apparatus is adapted to receive the hub in the manner of the spindle, adapted to be mounted to the brake mount and adapted to capture the spider plate against the brake mount.

According to another aspect of the invention, the apparatus can comprise:
a spindle portion having a spindle part, the spindle part being so adapted to receive the hub;
an adapter portion having a hollow and from which the spindle portion protrudes; and
a flange part protruding from the adapter portion, the flange part being so adapted to be mounted to the brake mount and capture the spider plate thereagainst.

According to another aspect of the invention, the apparatus can further comprise a bushing and the adapter portion can be adapted to receive the bushing in tight-fitting engagement.

This apparatus can be used in a method for repairing a damaged spindle in a mechanism of the type which, when manufactured, has: an axle tube terminating in a brake mount; a spindle extending from the brake mount; a spider plate mounted to the brake mount in surrounding relation to the spindle; a hub mounted to the spindle; and a wheel mounted to the hub.

This method comprises: severing the damaged spindle; welding the bushing to the axle tube; and operatively mounting the apparatus to the brake mount.

According to another aspect of the invention, in the method, the adapter part can be heated to receive the bushing.

According to another aspect of the invention: the bushing can be provided in the form of a bushing bracket combination; the bushing bracket combination can be bolted to the brake mount to position the bushing for welding; and a bracket portion of the bushing bracket combination can be severed from the bushing after the bushing has been welded in place.

Forming yet another aspect of the invention is apparatus for use with a mechanism of the type which, when manufactured, has: an axle tube terminating in a brake mount; a spindle extending from the brake mount; a spider plate mounted to the brake mount in surrounding relation to the spindle; a rotor mounted to the spindle; and a wheel mounted to the rotor.

This apparatus is adapted to receive the rotor in the manner of the spindle, adapted to be mounted to the brake mount and adapted to capture the spider plate against the brake mount.

According to another aspect of the invention, the apparatus can comprise: a spindle portion having a spindle part, the spindle part being so adapted to receive the rotor; an adapter portion having a hollow and from which the spindle portion protrudes; and a flange part protruding from the adapter portion, the flange part being so adapted to be mounted to the brake mount and capture the spider plate thereagainst.

According to another aspect of the invention, the apparatus can further comprise a bushing and the adapter portion can be adapted to receive the bushing in tight-fitting engagement.

This apparatus can be used in a method for repairing a damaged spindle in a mechanism of the type which, when manufactured, has: an axle tube terminating in a brake mount; a spindle extending from the brake mount; a spider plate mounted to the brake mount in surrounding relation to the spindle; a rotor mounted to the spindle; and a wheel mounted to the rotor, the method forming another aspect of the invention.

This method comprises: severing the damaged spindle; welding the bushing to the axle tube; and operatively mounting the apparatus to the brake mount.

According to another aspect of the invention, in the method, the adapter part can be heated to receive the bushing.

According to another aspect of the invention, the bushing can be provided in the form of a bushing bracket combination, the bushing bracket combination can be bolted to the brake mount prior to position the bushing for welding and a bracket portion of the bushing bracket combination can be severed and removed after the bushing part has been welded in place.

Advantages, features and characteristics of the invention will become apparent to persons of ordinary skill upon a review of the following detailed description with reference to the appended drawings, the latter being briefly described hereinafter.

### BRIEF DESCRIPTION OF THE DRAWINGS

FIG. 1 is a view of a prior art tractor;

FIG. 2 is an enlarged view of encircled area 2 of FIG. 1;

FIG. 3 is a view of FIG. 2 with the wheel and wheel nuts removed;

FIG. 4 is an enlarged view of encircled area 4 of FIG. 3;

FIG. 5 is a view of FIG. 4 with the axle nuts, axle shaft, axle gasket and caliper removed;

FIG. 6 is a view of FIG. 5 with the lock nut and spring clip removed;

FIG. 7 is a view of FIG. 6 with the hub, bearings, sleeve and seal removed;

FIG. 8 is a view of FIG. 7 with the spider plate removed and one of the nut and bolt assemblies used for securement thereof indicated in exploded view;

FIG. 9 is a view of FIG. 8 with the damaged spindle removed;

FIG. 10 is a view of FIG. 9 with a replacement spindle welded in place;

FIG. 11 is a view of apparatus according to an example embodiment of the invention;

FIG. 12 is a view of the structure of FIG. 11 positioned for use with the structure of FIG. 9;

FIG. 13 is a view of the structure of FIG. 12 assembled;

FIG. 14 is a view along section 14-14 of FIG. 13;

FIG. 15 is a view of the structure of FIG. 14 with the hub and axle reinstalled;

FIG. 16 is a view of the structure of FIG. 15 with the wheel reinstalled;

FIG. 17 is a view similar to FIG. 11;

FIG. 18 is an exploded view of the structure of FIG. 17;

FIG. 19 is a view of encircled area 19 of FIG. 18;

FIG. 19A is a plan view of the structure of FIG. 19;

FIG. 20 is a view of encircled area 20 of FIG. 17;

FIG. 20A is a plan view of the structure of FIG. 20;

FIG. 20B is a view along section 20B-20B of FIG. 20A;

FIG. 21A is a exploded view of the structure of FIG. 21.1;

FIG. 21B is a view of a prior art wheel assembly;

FIG. 21C is a view of the structure of FIG. 21B with the axle nuts removed;

FIG. 21D is a view of the structure of FIG. 21C with the wheel nuts and wheel removed;

FIG. 21E is another view of the structure of FIG. 21D;

FIG. 21F is a view of the structure of FIG. 21E with the brake removed;

FIG. 21G is a view of the structure of FIG. 21F with the spider removed and the spindle severed;

FIG. 22A is an exploded view of a spindle repaired according to another embodiment of the invention;

FIG. 22B is view similar to FIG. 21G;

FIG. 22C is a view of a bushing bracket positioned over the severed spindle;

FIG. 22D is a view of the structure of FIG. 22C with the bushing part welded in place;

FIG. 22E is a view of the structure of FIG. 22D with the bracket part severed from the bushing part and the spindle adapter installed;

FIG. 22F is a view of the structure of FIG. 22E with the brake reinstalled;

FIG. 22G is a view of the structure of FIG. 22F with the locknut installed;

FIG. 22H is a view of the structure of FIG. 22G with the wheel and wheel nuts installed;

FIG. 22I is a view of the structure of FIG. 22H with the axle shaft and nuts reinstalled;

FIG. 23A is an isometric view of the bushing bracket;

FIG. 23B is a view along E-E of FIG. 23C;

FIG. 23C is a view along C-C of FIG. 23D;

FIG. 23D is a front view of the structure of FIG. 23.1;

FIG. 23E is an enlarged view of detail D of FIG. 23C;

FIG. 23F is another isometric view of the structure of FIG. 23A;

FIG. 24A is an isometric view of part 15 of FIG. 22B;

FIG. 24B is a front view of the structure of FIG. 24A;

FIG. 24C is a view along A-A of FIG. 24B;

FIG. 24D is another isometric view of the structure of FIG. 24A;

FIG. 24E is a view of detail F of FIG. 24D;

FIG. 25A is a exploded view of the structure of FIG. 25B;

FIG. 25B is a view of a prior art wheel assembly;

FIG. 25C is a view of the structure of FIG. 25B with the axle nuts removed;

FIG. 25D is a view of the structure of FIG. 25C with the wheel nuts and wheel removed;

FIG. 25E is another view of the structure of FIG. 25D;

FIG. 25F is a view of the structure of FIG. 25E with the hub removed;

FIG. 25G is a view of the structure of FIG. 25F with the rotor removed;

FIG. 25H is a view of the structure of FIG. 25G with the spider removed and the spindle severed;

FIG. 26A is an exploded view of a spindle repaired according to another embodiment of the invention;

FIG. 26B is view similar to FIG. 25H;

FIG. 26C is a view of a bushing bracket positioned over the severed spindle and welded in place;

FIG. 26D is a view of the structure of FIG. 26C with the bracket part severed from the bushing part and the spider installed;

FIG. 26E is a view of the structure of FIG. 26D with the spindle installed;

FIG. 26F is a view of the structure of FIG. 26E with the rotor reinstalled;

FIG. 26G is a view of the structure of FIG. 26F with the hub installed;

FIG. 26H is a view of the structure of FIG. 26G with the locknut installed;

FIG. 26I is a view of the structure of FIG. 26H with the wheel and wheel nuts installed;

FIG. 26J is a view of the structure of FIG. 26I with the axle shaft and nuts reinstalled;

FIG. 27A is an isometric view of the bushing bracket;

FIG. 27B is a view along B-B of FIG. 27C.

FIG. 27C is a view along A-A of FIG. 27D;

FIG. 27D is a front view of the structure of FIG. 27A;

FIG. 27E is an enlarged view of detail B of FIG. 27C;

FIG. 27F is another isometric view of the structure of FIG. 27A;

FIG. 28A is an isometric view of part 18 of FIG. 26A;

FIG. 28B is a front view of the structure of FIG. 28A;

FIG. 28C is a view along A-A of FIG. 28B;

FIG. 28D is another isometric view of the structure of FIG. 28A; and

FIG. 28E is a view of detail F of FIG. 28D.

### DETAILED DESCRIPTION OF EXAMPLE EMBODIMENTS

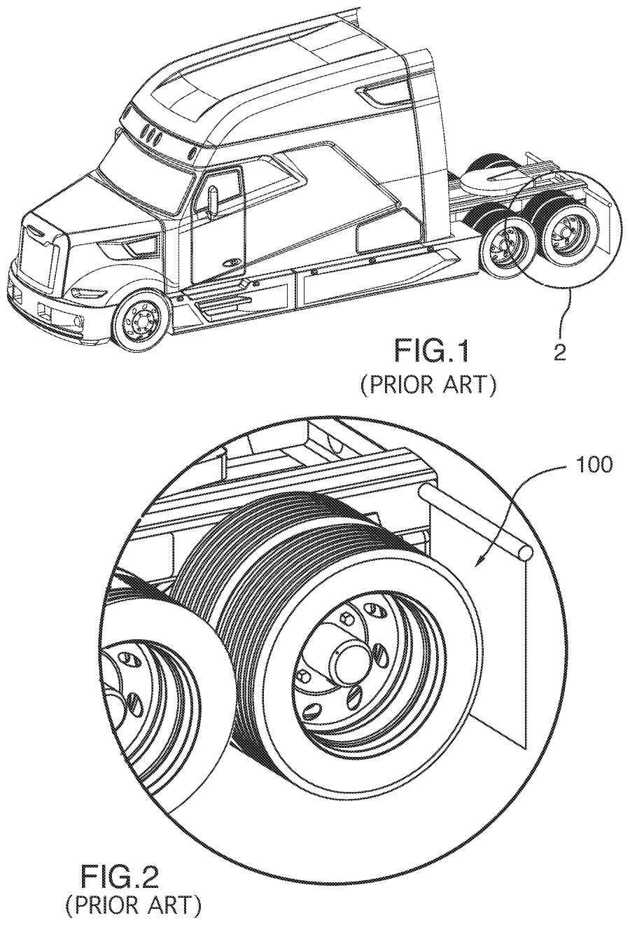

Example embodiments of the inventive apparatus and method are described below but as an initial matter both should be understood to be for use mechanisms of the general prior art type shown in FIGS. 1 and 2, namely, a wheel assembly 100.

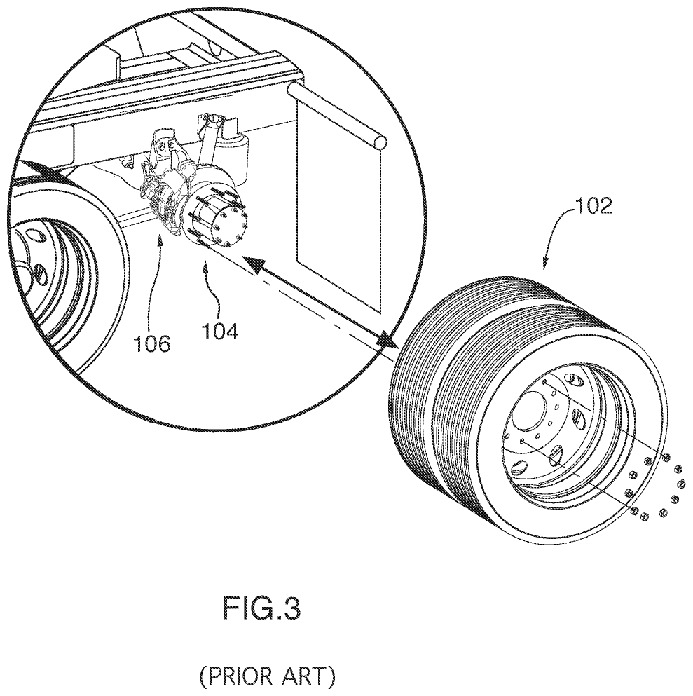

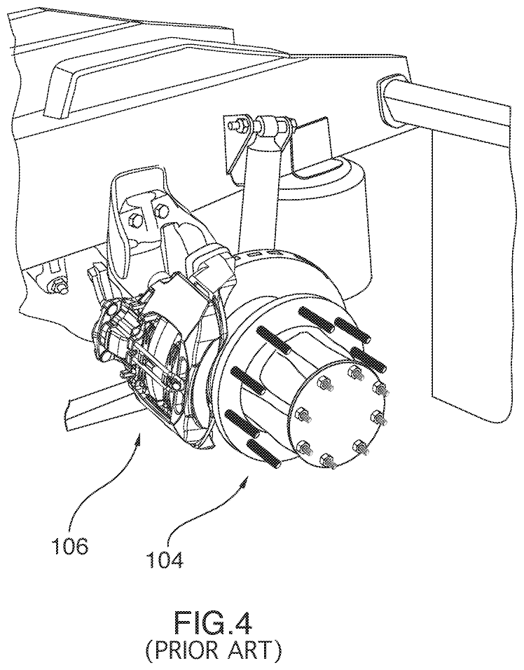

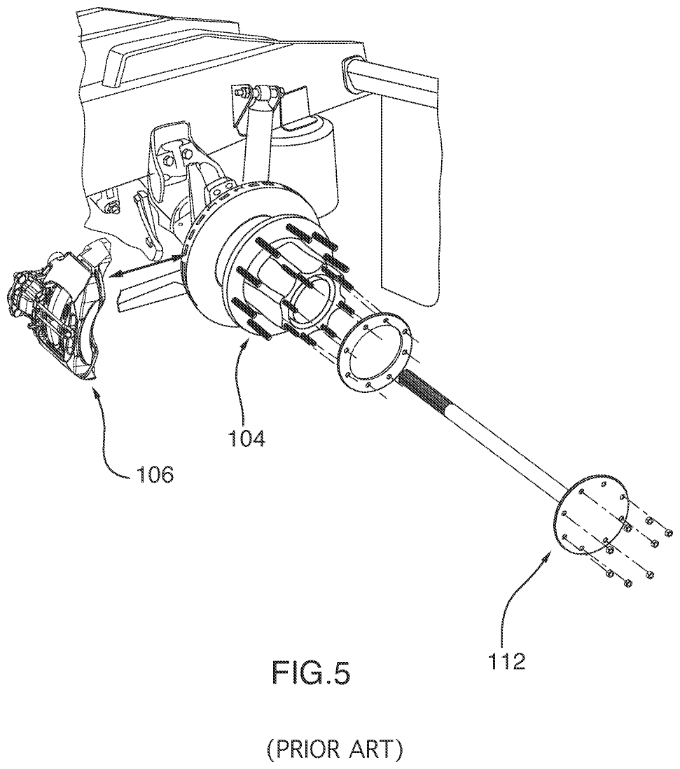

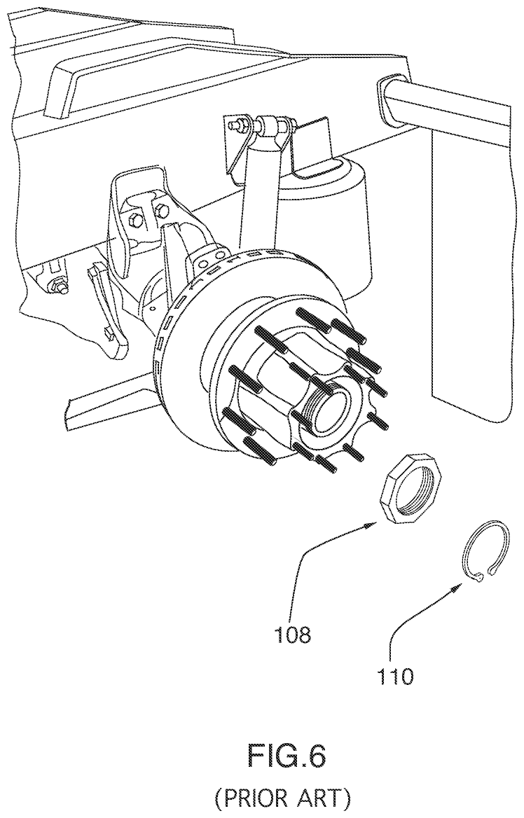

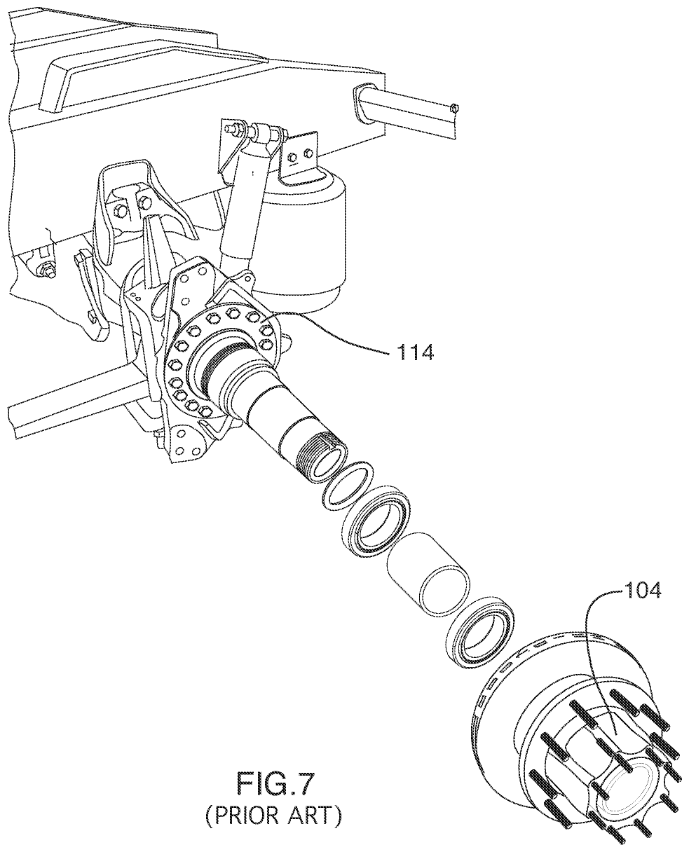

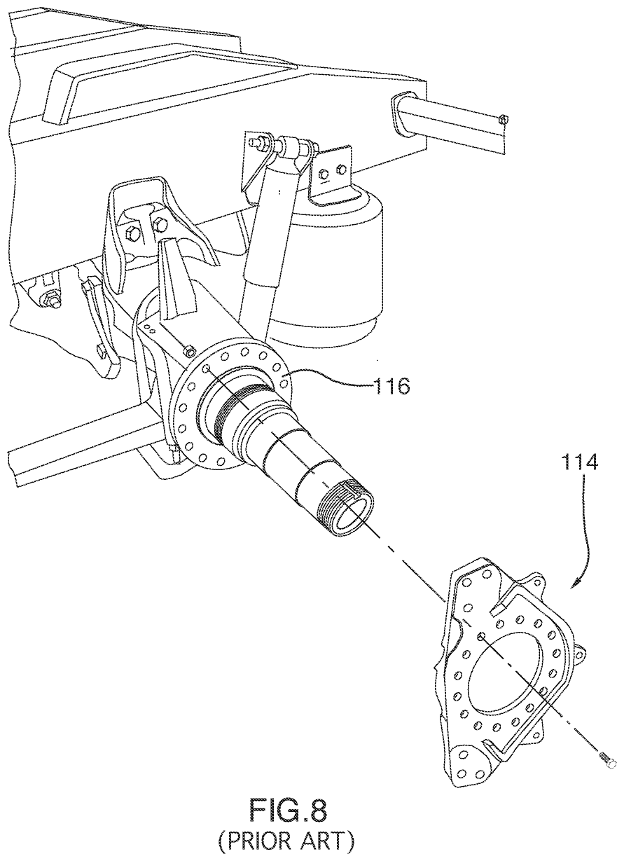

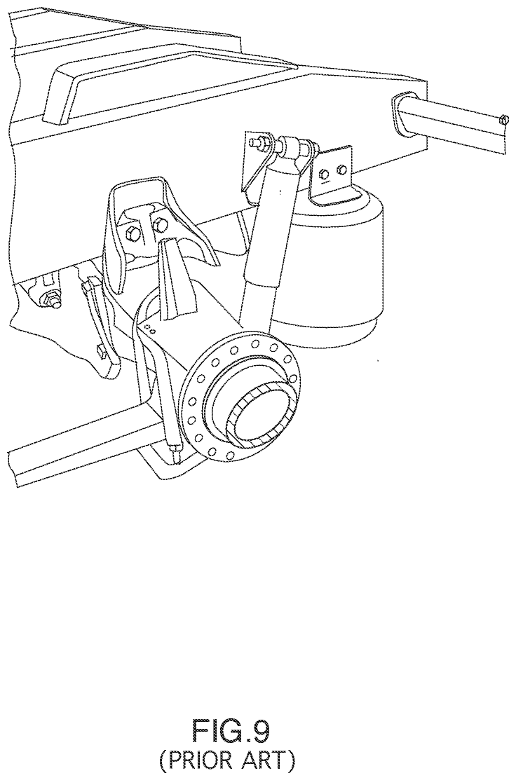

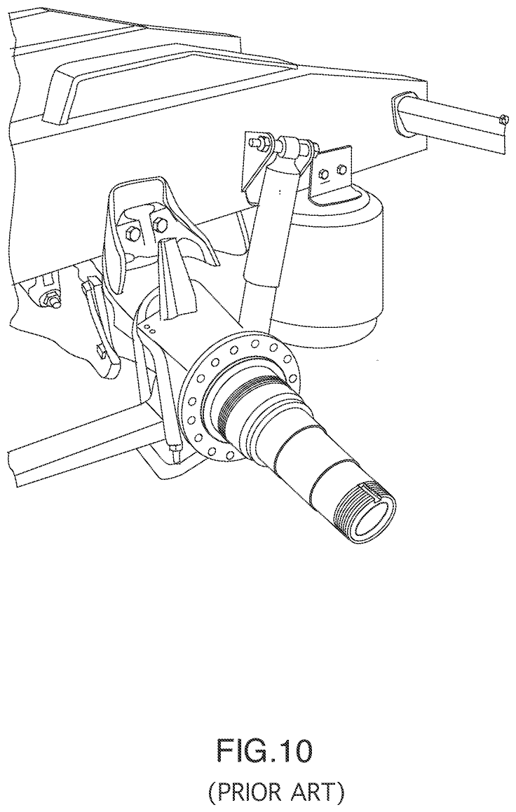

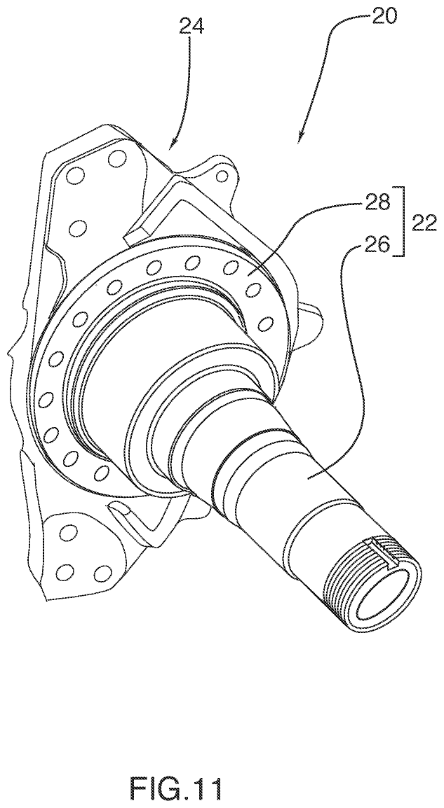

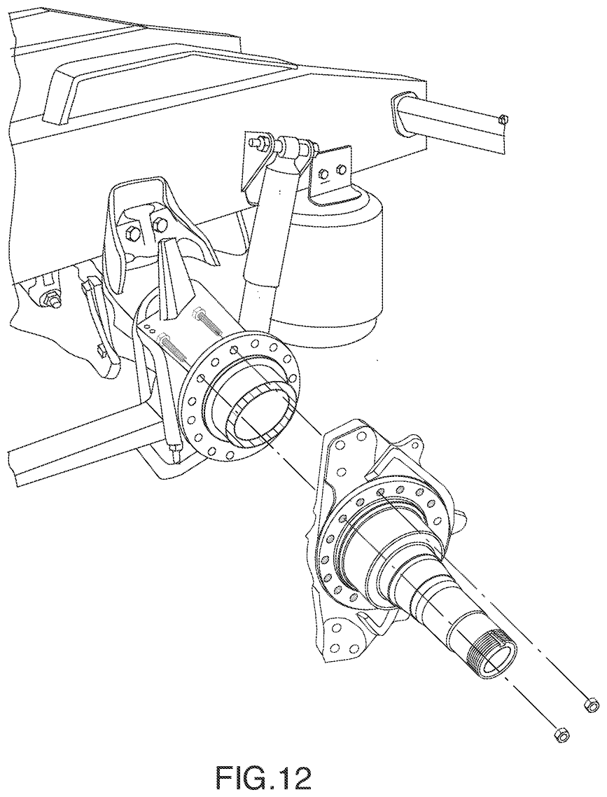

This mechanism will be understood to include, with reference to the sequence of FIGS. 1-8:
a wheel 102,
a hub 104 and caliper 106 which are revealed when the wheel is removed from the hub as shown in FIG. 3
a lock nut 108 and spring clip 110 which are accessible for removal when the axle 112 is removed as indicated by FIGS. 5, 6
a spider plate 114 which is revealed when hub 104 is removed as in FIG. 7
a brake mount 116 which is revealed when the spider plate 114 is removed, as in FIG. 8

The example apparatus 20 is shown in FIG. 11 and will be understood to comprise a spindle portion 22 and a spider portion 24, tack welded together.

The spindle portion has a spindle part 26 that has the shape of the prior art spindle and a flange part 28.

The spider portion has the general shape of the prior art spider.

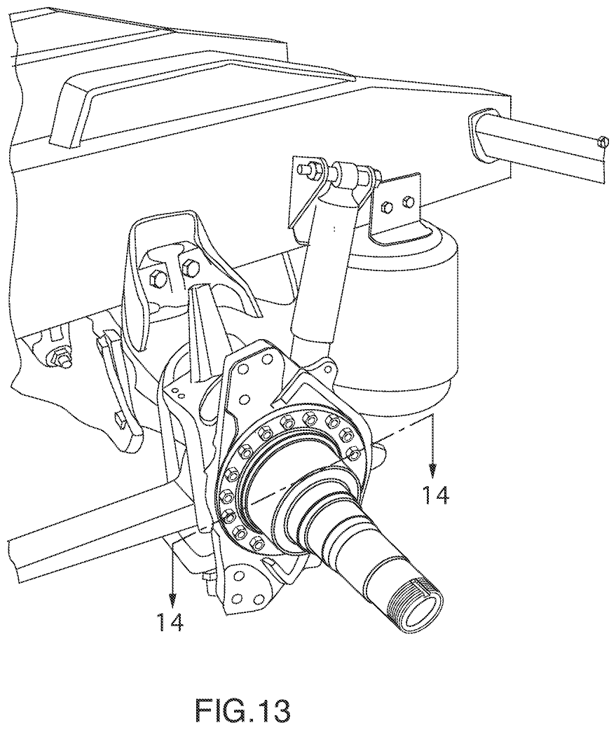

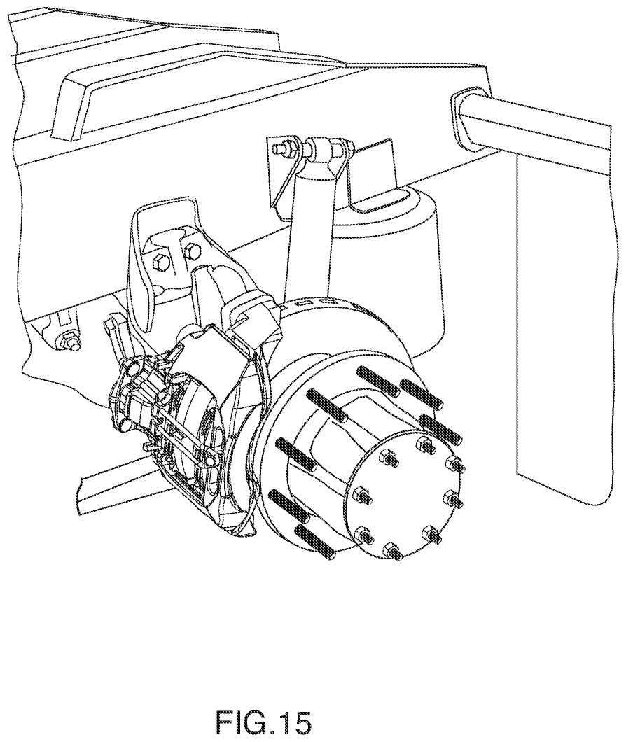

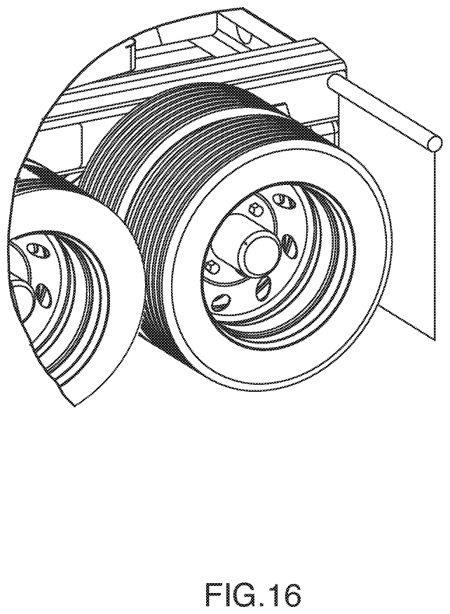

The example method involves the example apparatus and will be understood to commence with the disassembly of a damaged wheel assembly to expose the spindle as shown in FIG. 8 and the following steps:
severance of the (damaged) spindle from the balance of the tube by cutting or the like at the factory weld, as indicated in FIG. 9
mounting the FIG. 11 apparatus to the brake mount as indicated in FIG. 13
operatively reinstalling the axle as hub as in FIG. 15; and
mounting the wheel to the hub, as in FIG. 16

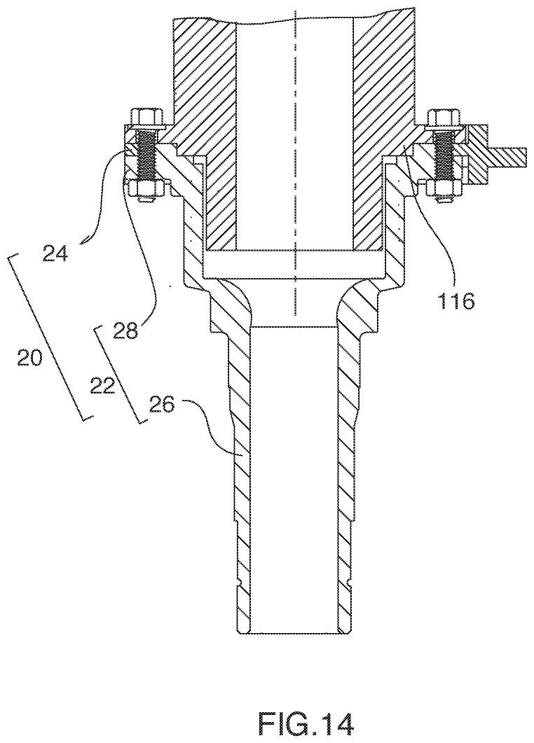

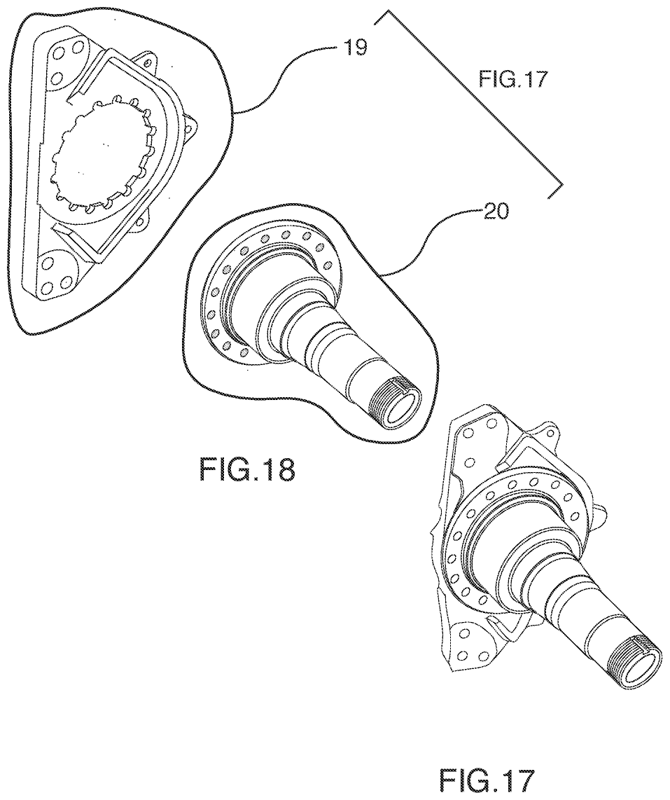

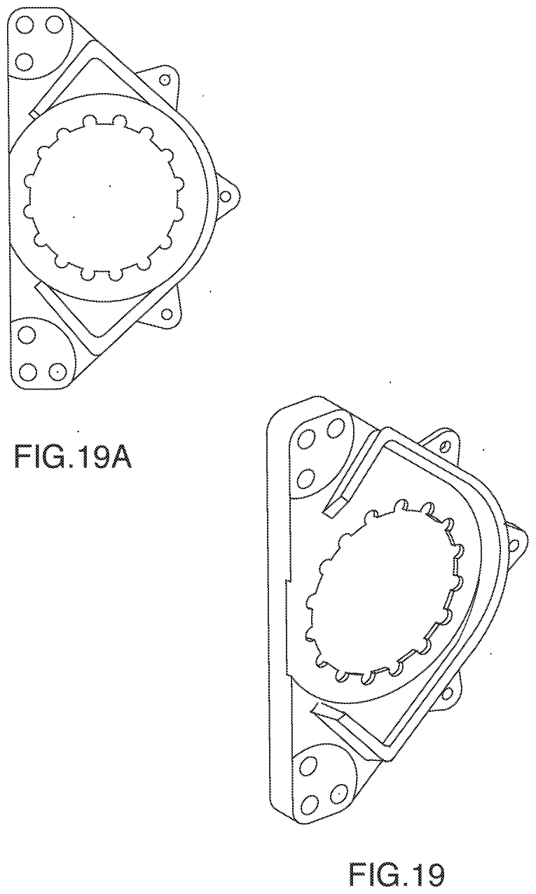

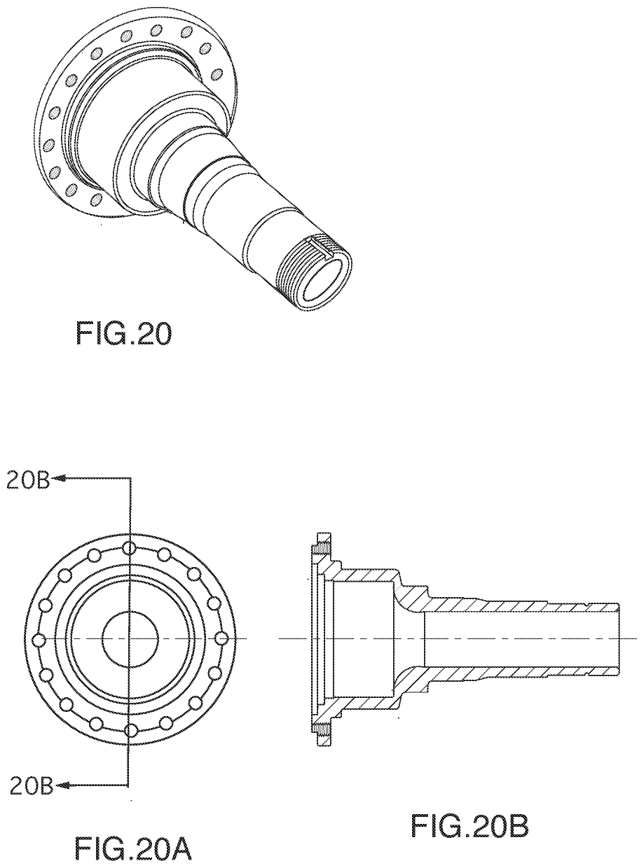

FIG. 17 through 20B show the apparatus 20 in further detail. More particularly, it will be seen in these figures that the flange of the spindle portion has a stepped hollow in the rear face therein adapted to receive the brake mount and spindle stub in a clearance fit, as indicated in FIG. 14.

Variations on the above are possible.

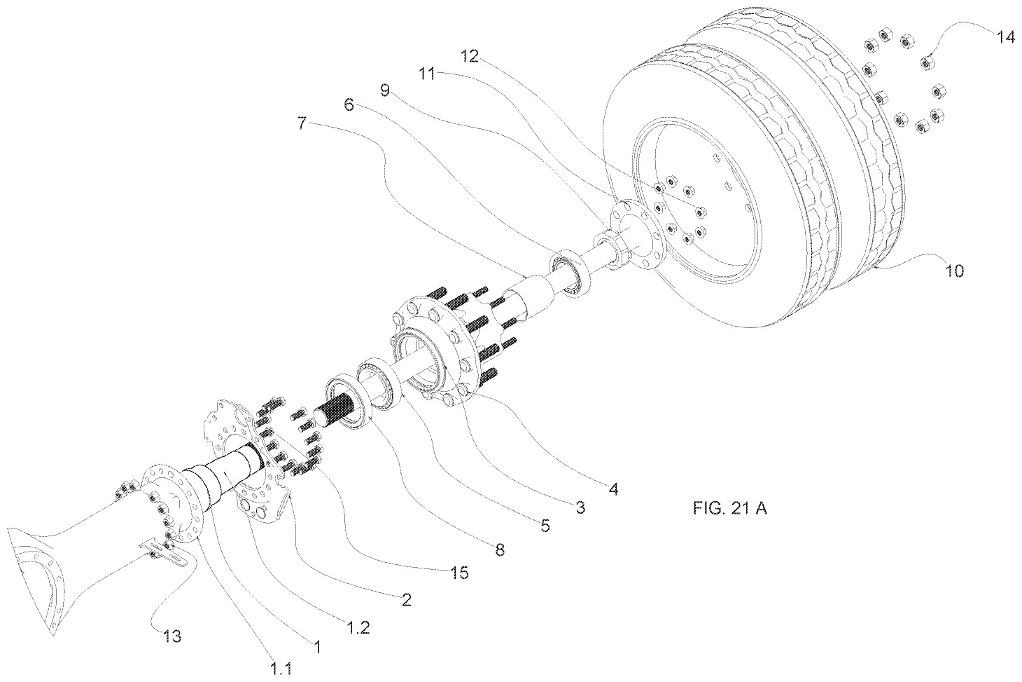

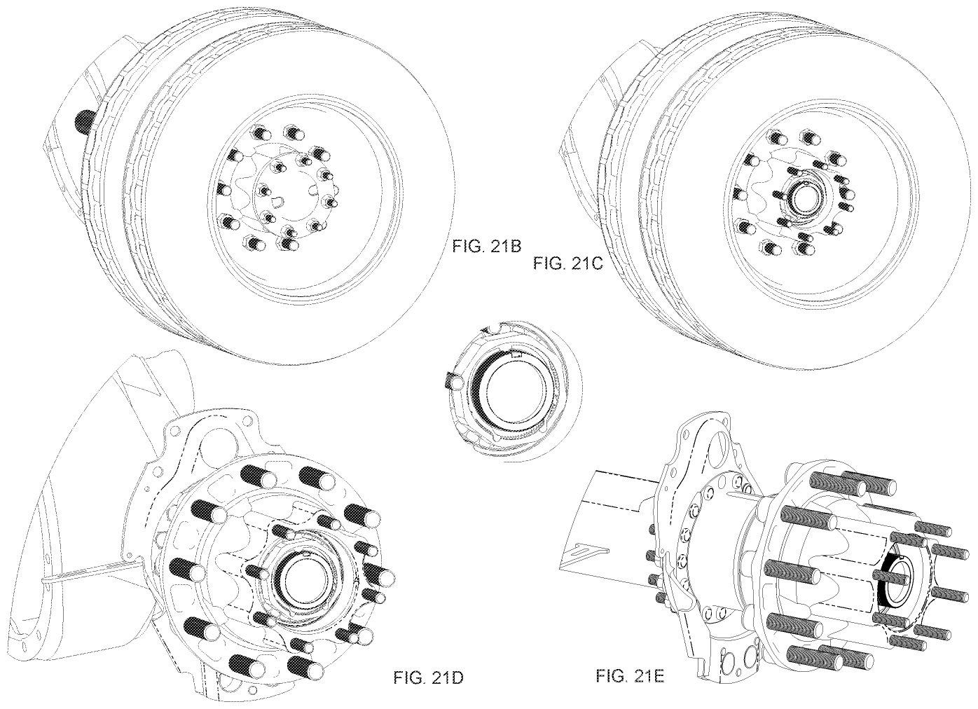

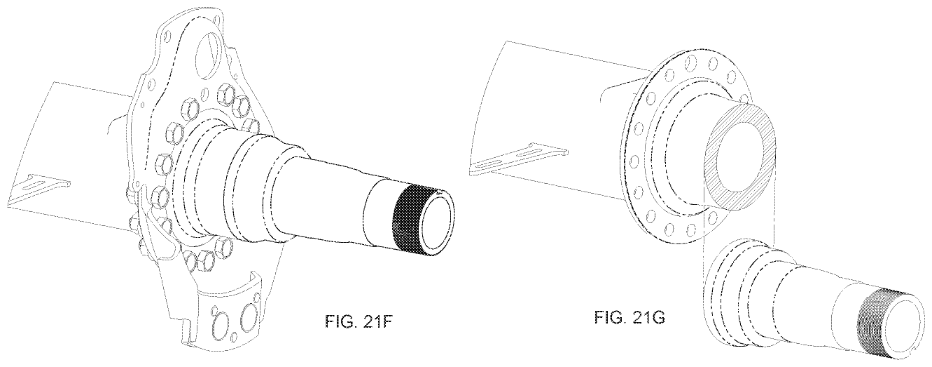

One variation involves a mechanism of the type shown in FIG. 21B which, when manufactured, has an axle tube 1 terminating in a brake mount 1.1, a spindle 1.2 extending from the brake mount, a spider plate 2 mounted to the brake mount in surrounding relation to the spindle, a hub 3 mounted to the spindle and a wheel 10 mounted to the hub.

This variation involves the structure shown in FIGS. 24A through 24E and the structure shown in FIG. 23A through 23F.

The structure shown in FIGS. 24A through 24E will be understood to be adapted to receive the hub in the manner of the spindle, adapted to be mounted to the brake mount and adapted to capture the spider plate against the brake mount and will be seen to comprise a spindle portion S, an adapter portion A and a flange part F.

The spindle portion has a spindle part, the spindle part being so adapted to receive the hub.

The adapter portion has a hollow H and has the spindle portion protruding therefrom.

The flange part protrudes from the adapter portion and is adapted to be mounted to the brake mount and capture the spider plate thereagainst.

The structure of FIGS. 23A through 23F .comprises a bushing B1 and a bracket B2 integrally formed therewith to define a combination, the bushing being adapted to be received by the adapter portion in tight fitting engagement.

The above apparatus can be used for repairing a damaged spindle in the apparatus of FIG. 21B

This step is generally similar to the method previously described, i.e. requiring removal of the components necessary to expose the damaged spindle and severing the damaged spindle.

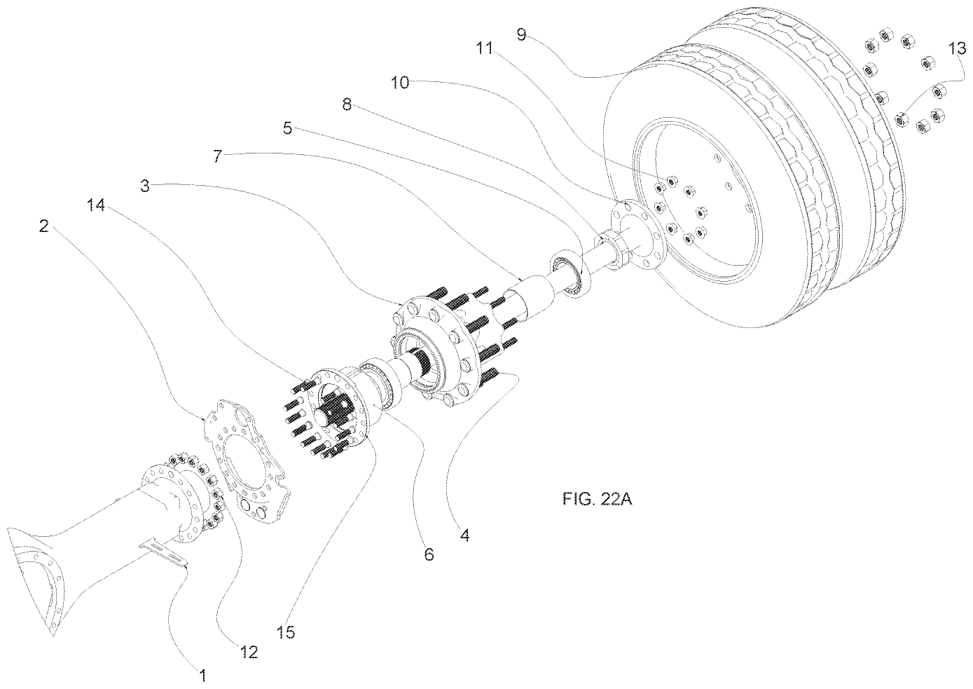

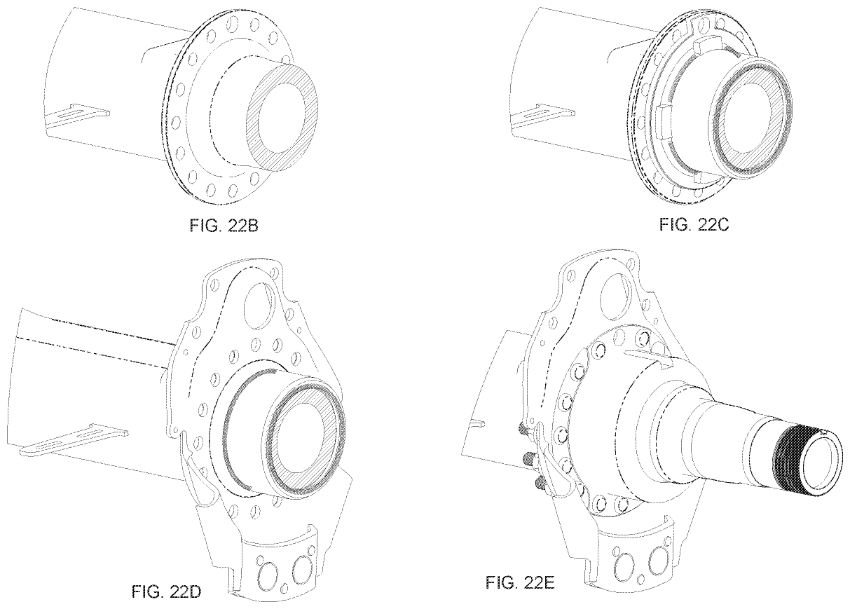

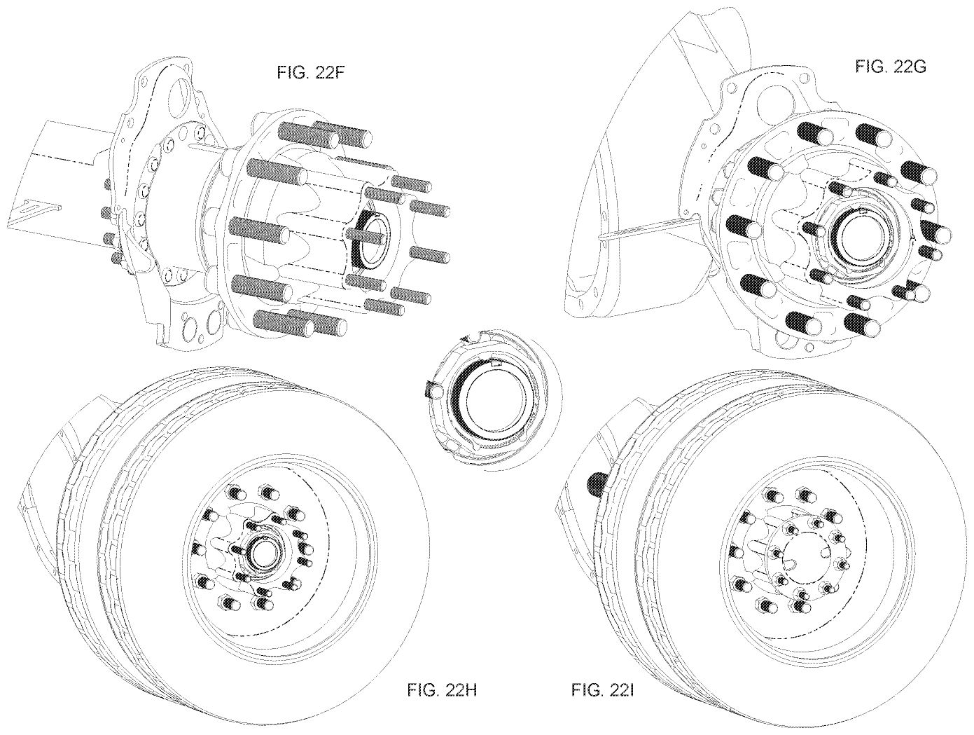

However, in this method, prior to replacement of the wheel, hub, etc.:
the bushing bracket combination is bolted to the brake mount in surrounding relation to the spindle stub, and beads of weld are placed at the ends of the bushing part, as indicated by the sequence of FIGS. 22B and 22C;
the bracket portion is severed, with a grinder or the like, from the bushing portion at waisted portion W, to permit installation of the spider plate, as indicated by the sequence of FIGS. 22C to 22D
the apparatus is mounted to the brake mount to capture thereagainst the spider plate, as indicated by the sequence of FIGS. 22D to 22E

Notably, although not shown, the adapter part of the apparatus is heated, with a welding torch or the like, prior to installation on the bushing, thereby to ensure tight-fitting engagement once cooled.

Yet another variation involves a mechanism of the type shown in FIG. 31B which, when manufactured, has an axle tube 1 terminating in a brake mount 1.1, a spindle 1.2 extending from the brake mount, a spider plate 2 mounted to the brake mount in surrounding relation to the spindle, a rotor 3 mounted to the spindle and a wheel 10 mounted to the rotor.

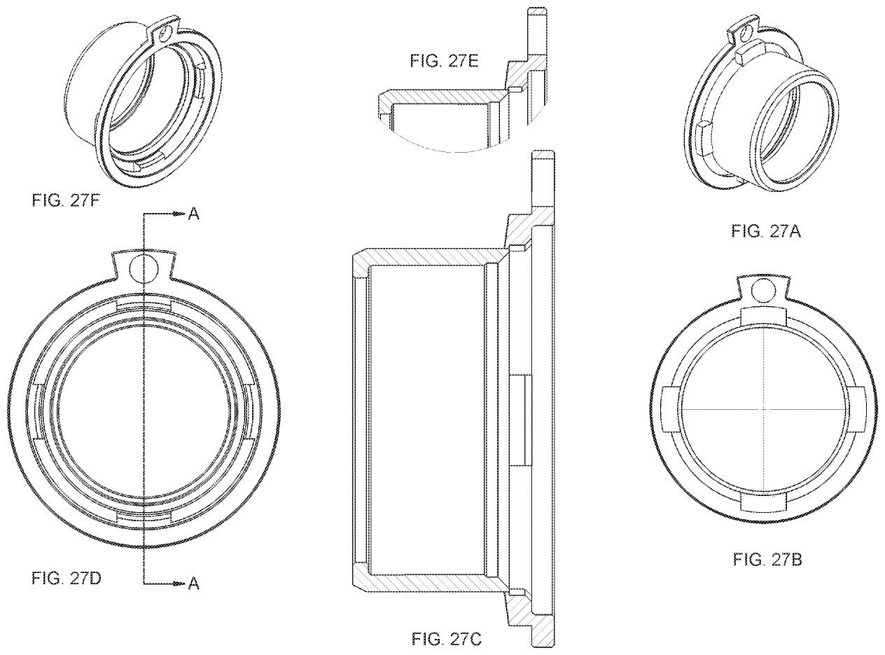

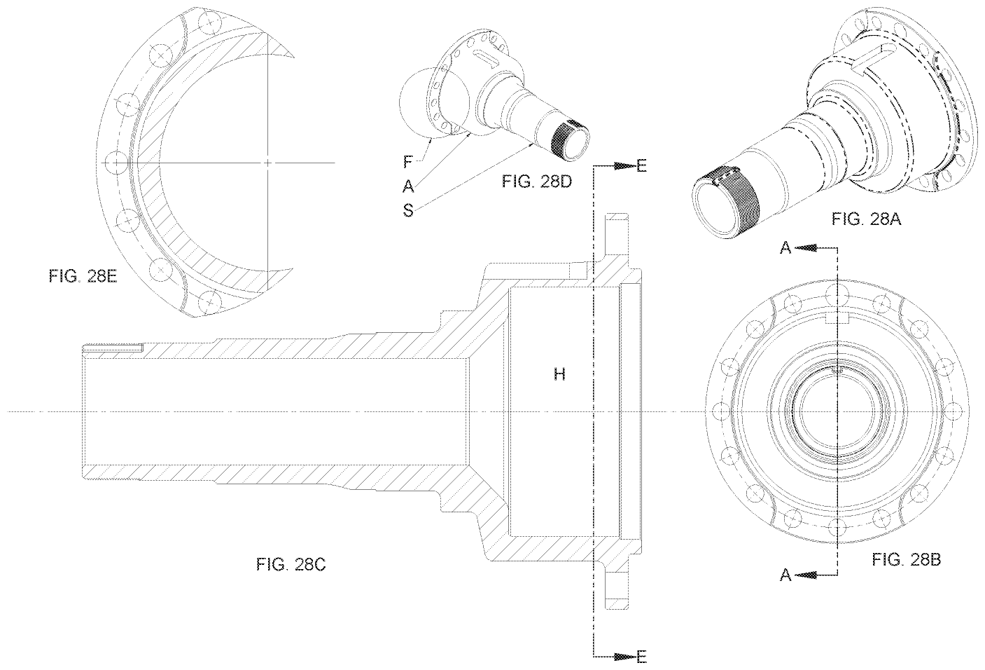

This variation involves the structure shown in FIGS. 28A through 28E and the structure shown in FIG. 27A through FIG. 27G

The structure shown in FIG. 28A through 28E which will be understood to be adapted to receive the rotor in the manner of the spindle, adapted to be mounted to the brake mount and adapted to capture the spider plate against the brake mount will be seen to comprise a spindle portion S, an adapter portion A and a flange part F.

The spindle portion has a spindle part, the spindle part being so adapted to receive the rotor.

The adapter portion having a hollow and has the spindle portion protruding therefrom.

The flange part protrudes from the adapter portion and is adapted to be mounted to the brake mount and capture the spider plate thereagainst.

The structure of FIG. 27A through 27G is identical to the structure of FIGS. 23A through 23G and will thus be understood to comprise a bushing and a bracket formed integrally therewith to define a bushing bracket combination, the bushing being adapted to be received by the adapter portion in tight fitting relation.

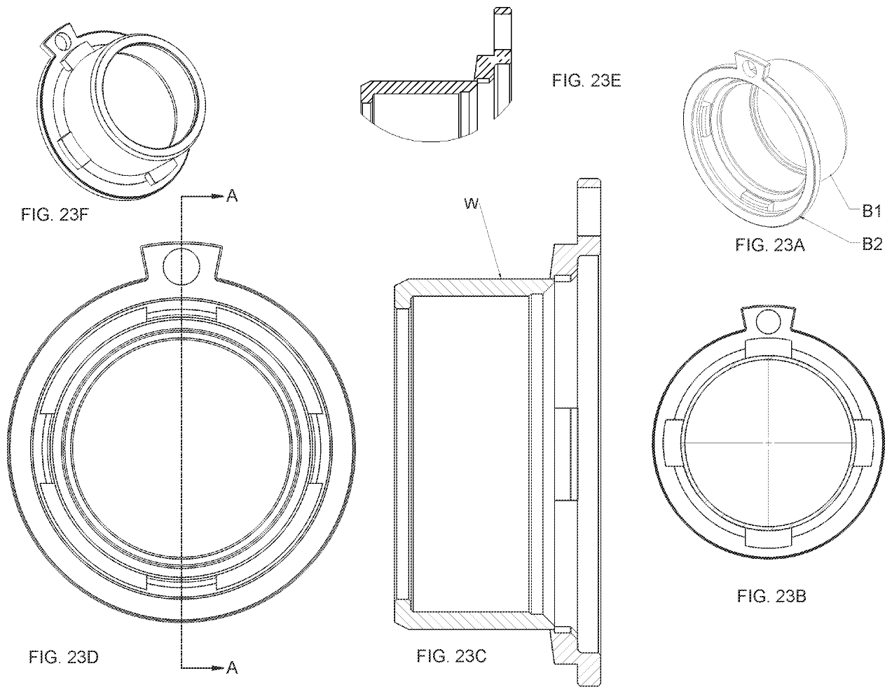

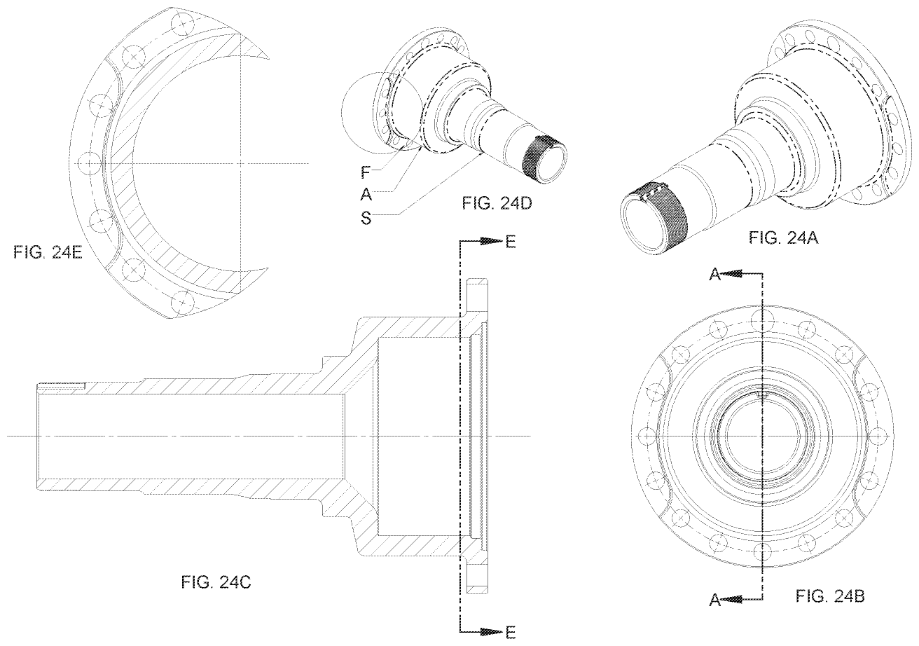

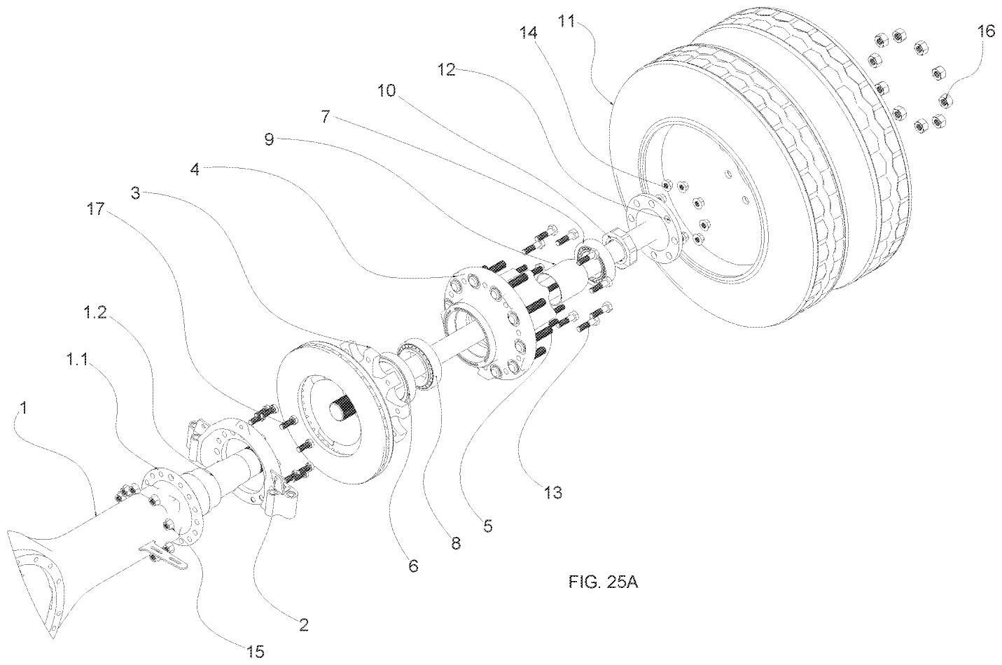

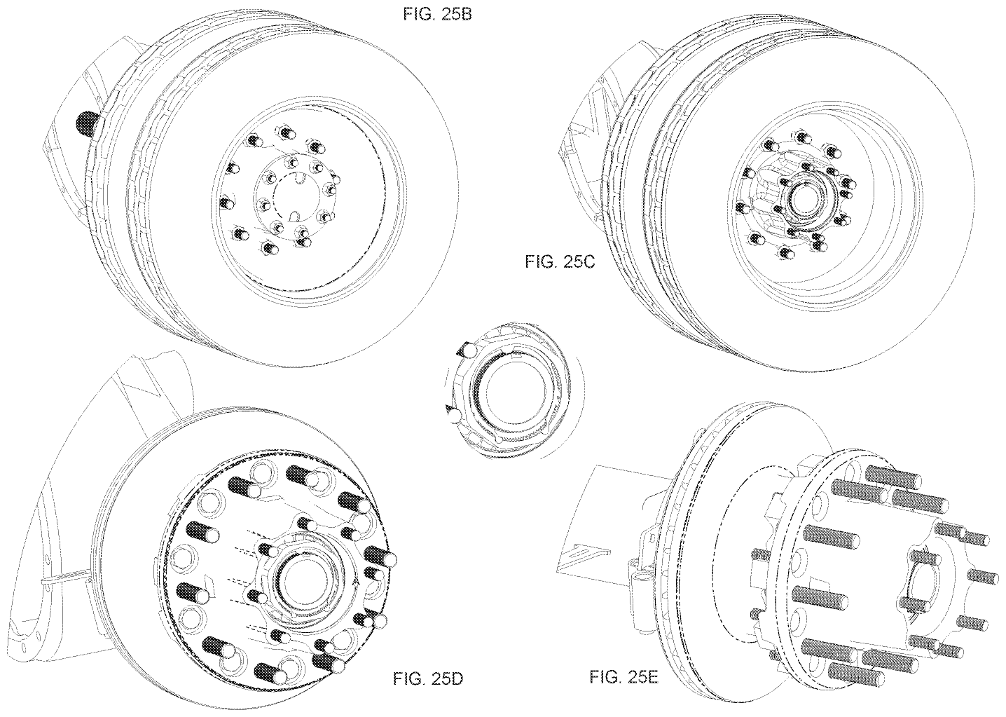

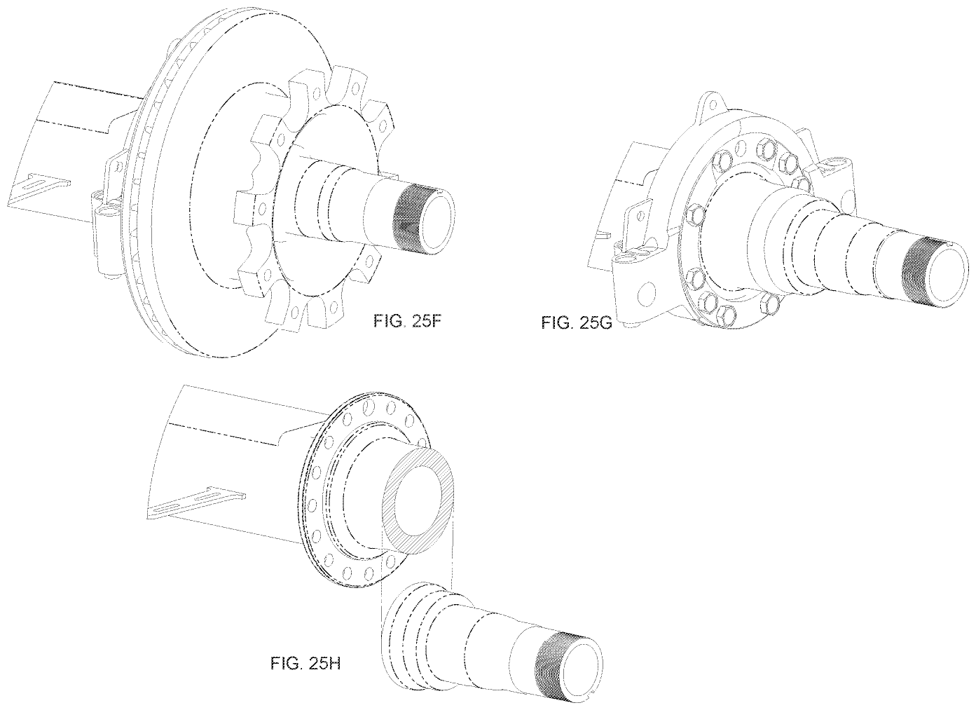

The above apparatus can be used for repairing a damaged spindle in the apparatus of FIG. 25B

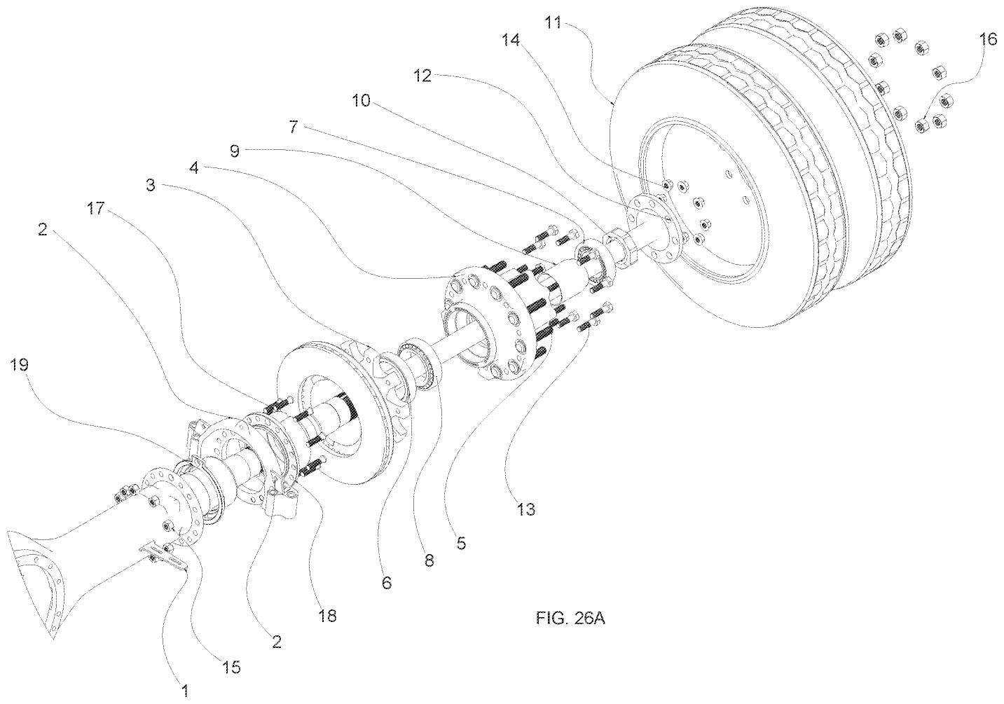

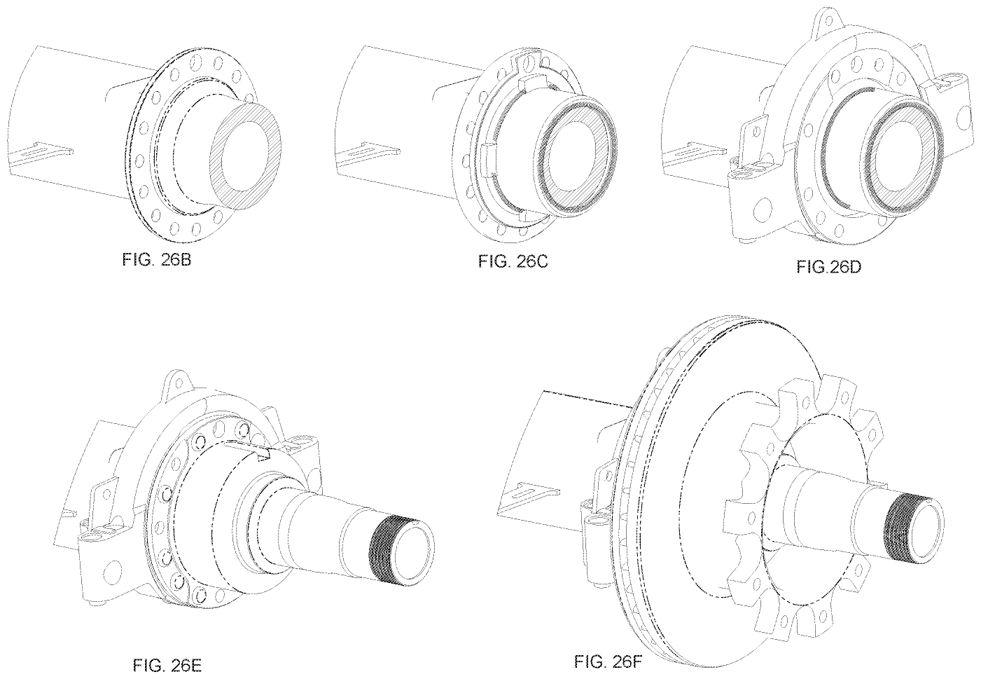

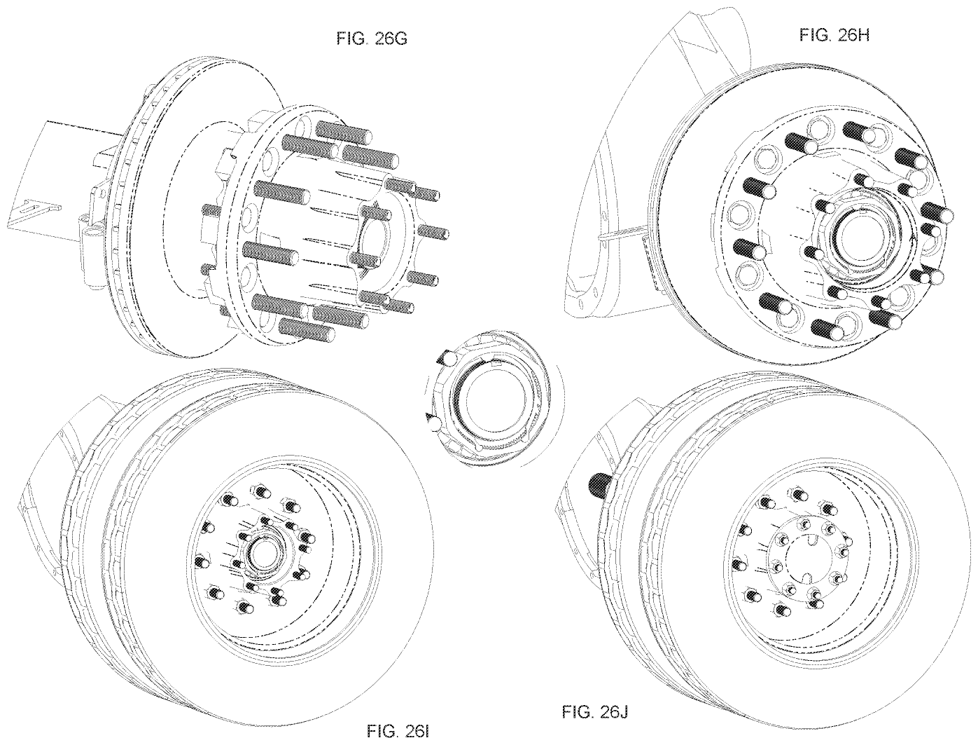

This method again requires: removal of the components necessary to expose the damaged spindle; severing the damaged spindle [FIG. 26B]; mounting the bushing bracket combination to the brake mount and welding the bushing [FIG. 26C]; severing and removing the bracket portion; heating the adapter part; positioning the adapter part around the bushing; mounting the apparatus to the brake mount; and reinstalling the rotor, wheel, etc.

However, in this embodiment, the spider plate is positioned against the brake mount before the apparatus is mounted, as indicated in FIG. 26E

Yet further variations are possible.

Accordingly, the invention should be understood to be limited only by the accompanying claims, purposively construed.

1. Apparatus for use with a mechanism of the type which, when manufactured, has an axle tube terminating in a brake mount, a spindle extending from the brake mount, a spider plate mounted to the brake mount in surrounding relation to the spindle, a brake assembly mounted to the brake mount in surrounding relation to the spindle, a hub mounted to the spindle and a wheel mounted to the hub, the apparatus comprising:
an assembly adapted to receive the hub in the manner of the spindle, adapted to be mounted to the brake mount in the manner of the spider plate and adapted to receive the brake in the manner of the spider plate.

2. The apparatus of claim 1, wherein the assembly comprises
a spindle portion having a spindle part that is adapted to receive the hub in the manner of the spindle and a flange part from which the spindle part protrudes; and
a spider portion having a hollow adapted to receive the flange part, the spider portion and the flange part being adapted to be mounted to the brake mount in the manner of the spider plate and adapted to receive the brake in the manner of the spider plate.

3. A method for repairing a damaged spindle in a mechanism of the type which, when manufactured, has an axle tube terminating in a brake mount, a spindle extending from the brake mount; a spider plate mounted to the brake mount in surrounding relation to the spindle; a brake assembly mounted to the brake mount in surrounding relation to the spindle; a hub mounted to the spindle; and a wheel mounted to the hub,
the method comprising:
operatively mounting the apparatus of claim 2 to the brake mount.

4. Apparatus for use with a mechanism of the type which, when manufactured, has an axle tube terminating in a brake mount, a spindle extending from the brake mount, a spider plate mounted to the brake mount in surrounding relation to the spindle, a hub mounted to the spindle and a wheel mounted to the hub, the apparatus comprising:
an assembly adapted to receive the hub in the manner of the spindle, adapted to be mounted to the brake mount and adapted to capture the spider plate against the brake mount.

5. The apparatus of claim 4, wherein the assembly comprises:
a spindle portion having a spindle part, the spindle part being so adapted to receive the hub;
an adapter portion having a hollow and from which the spindle portion protrudes; and
a flange part protruding from the adapter portion, the flange part being so adapted to be mounted to the brake mount and capture the spider plate thereagainst.

6. The apparatus of claim 5, further comprising a bushing and wherein the adapter portion is adapted to receive the bushing in tight-fitting engagement.

7. A method for repairing a damaged spindle in a mechanism of the type which, when manufactured, has an axle tube terminating in a brake mount, a spindle extending from the brake mount; a spider plate mounted to the brake mount in surrounding relation to the spindle; a hub mounted to the spindle; and a wheel mounted to the hub,
the method comprising:
severing the damaged spindle;
welding the bushing to the axle tube; and
operatively mounting the apparatus of claim 6 to the brake mount.

8. The method of claim 7, wherein the adapter part is heated to receive the bushing.

9. The method of claim 7, wherein the bushing is provided in the form of a bushing bracket combination, the bushing bracket combination is bolted to the brake mount to secure the bushing for welding and a bracket portion of the bushing bracket is severed and removed after the bushing part has been welded in place.

10. Apparatus for use with a mechanism of the type which, when manufactured, has an axle tube terminating in a brake mount, a spindle extending from the brake mount, a spider plate mounted to the brake mount in surrounding relation to the spindle, a rotor mounted to the spindle and a wheel mounted to the rotor, the apparatus comprising:
a structure adapted to receive the rotor in the manner of the spindle, adapted to be mounted to the brake mount and adapted to capture the spider plate against the brake mount.

11. The apparatus of claim 10, wherein the structure comprises:
a spindle portion having a spindle part, the spindle part being so adapted to receive the rotor;
an adapter portion having a hollow and from which the spindle portion protrudes; and
a flange part protruding from the adapter portion, the flange part being so adapted to be mounted to the brake mount and capture the spider plate thereagainst.

12. The apparatus of claim 11, further comprising a bushing and wherein the adapter portion is adapted to receive the bushing in tight-fitting engagement.

13. A method for repairing a damaged spindle in a mechanism of the type which, when manufactured, has an axle tube terminating in a brake mount, a spindle extending from the brake mount; a spider plate mounted to the brake mount in surrounding relation to the spindle; a rotor mounted to the spindle; and a wheel mounted to the rotor,
the method comprising:
severing the damaged spindle;
welding the bushing to the axle tube;
operatively mounting the apparatus of claim 11 to the brake mount.

14. The method of claim 13, wherein the adapter part is heated to receive the bushing.

15. The method of claim 13, wherein the bushing is provided in the form of a bushing bracket combination, the bracket is bolted to the brake mount to position the bushing for welding and is severed and removed after the bushing part has been welded in place.
